(19) United States
(12) Patent Application Publication
(10) Pub. No.: US 2003/0140948 A1
(43) Pub. Date: Jul. 31, 2003

(54) Clean equipment for removing polymer residues on sidewalls of metal lines and method thereof

(76) Inventors: Chih-Jung Ni, Hsin-Chu (TW); Jia-Shing Jan, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/057,906

(22) Filed: Jan. 29, 2002

(51) Int. Cl. B08B 3/04; B08B 3/08; B08B 3/10

(52) U.S. Cl. 134/26; 134/61; 134/102.1

(57) ABSTRACT

A clean equipment for removing polymer residues on sidewalls of metal lines and method thereof are provided. The present clean equipment comprises a stripping solution bath, at least an organic solvent bath, an overflow bath and a dryer. A gas bubbler and a lattice-like cassette stage are positioned within the organic solvent bath. The gas bubbler provides gas flow in the organic solvent bath to increase the convection of the organic solvent. The lattice-like cassette stage is used for supporting cassettes for carrying wafers. By way of increasing the number of bubbling apertures of the gas bubbler and designing the gas bubbler structure in a way that preventing the bubbling apertures from being blocked by the lattice-like cassette stage, the convection effectiveness of the organic solvent is increased. Thereby, the stripping solution can be effectively removed with the organic solvent. Besides, lengthening the drip dry time of the wafer over each bath so as to eliminate the quantity of the stripping solution left on the wafer drawn in the overflow bath. By the above measures, metal corrosion occurred on the sidewalls of the metal lines formed on the wafer is significantly reduced.

### BACKGROUND OF THE INVENTION

1. Field of the Invention

The present invention relates to a wafer clean equipment and method thereof, and more particularly to a clean equipment for removing polymer residues on sidewalls of metal lines and method thereof.

2. Description of the Prior Art

For very large scale integration (VLSI) semiconductor devices, metal-oxide-semiconductor transistors and other devices are connected with each other via several metal line layers. FIG. 1 shows a metal line layer structure 10 established on a semiconductor substrate (not shown). The metal line layer structure 10 comprises a barrier layer 101, several metal lines 102 and an anti-reflective coating (ARC) layer 103. The barrier layer 101 is used to prevent spiking between the metal line 102 and the semiconductor substrate (not shown). The barrier layer 101 can a titanium nitride (TiN) layer, a titanium (Ti) layer, a tungsten nitride (TiW) layer and a titanium/tungsten alloy (Ti/W) layer. The metal line 102 generally is formed of aluminum (Al) or aluminum/copper (Al/Cu) alloy. The surface of the metal line 102 has high reflectivity, which gives adverse effect on patterning of the metal line 102 with a photolithography process. Hence, the anti-reflective coating layer 103 is formed on a metal layer to be formed as the metal lines 102 before the photolithography process so as to eliminate the above problem. The anti-reflective coating layer 103 can be formed of any non-reflective material. However, the anti-reflective coating layer 103 can be formed of a material the same with that of the barrier layer 101 to reduce the manufacturing cost.

The manufacturing steps for forming the metal line layer structure 10 are described as follows. Firstly, a photoresistor layer (not shown) is formed on the anti-reflective coating layer 103. A pattern of the metal line layer is transferred unto the photoresistor layer by a photolithography technique. Next, using the patterned photoresistor layer as an etching mask to perform a dry etching process to form the metal line layer structure 10. Then, the photoresistor layer is removed. However, during the dry etching process, the plasma etchants react with the photoresistor layer to form polymer residues 104, containing carbon, titanium, chloride and aluminum etc., on sidewalls of the metal lines 102. Several clean steps are applied on the wafer with the metal line layer structure 10 formed thereon to remove polymer residues 104 on sidewalls of the metal line 102, which are shown in FIG. 3.

FIG. 3 shows a schematic conventional clean equipment used to remove polymer residues 104 on sidewalls of the metal lines 102 formed on the wafer. The conventional clean equipment comprises a chemical booth 30 and a dry booth 32. The chemical booth 30 includes a stripping solution bath 301, a first methanol bath 302 and a second methanol bath 303. The dry booth 32 includes an overflow bath 321 and a spin dryer 322. Initially, the wafer is immersed in the stripping solution bath 301 to remove polymer residues 104 on sidewalls of the metal line 102. The composition of the stripping solution comprises alcohol amine, dihydroxylbenzene, water, hydroxylamine and anticorrosion agent. Alcohol amine is used to attack aluminum or its oxide to remove polymer residues 104 from the sidewalls of the metal lines 102 and served as a solvent. Water is used to dissolve aqueous polymer residues. Dihydroxylbenzene is used as an anticorrosion agent. Hydroxylamine is used to attack aluminum or its oxide to remove polymer residues 104 form the sidewalls of the metal lines 102.

Continually, the wafer is immersed in the first methanol bath 302 for removing the stripping solution left on the wafer. Then, the wafer is immersed in a second methanol bath 303 for further removing the stripping solution left on the wafer. Thereafter, the wafer is immersed in the overflow bath 321, and then water flow removes away the stripping solution and methanol left on the wafer. Finally, spin drying water left on the wafer with a spin dryer 322.

Referring to FIG. 2, after the above several clean steps are completed, metal corrosion occurs on the sidewalls of the metal lines 102. There is a large quantity of recesses occurring on the sidewalls of the metal lines 102, which look like mouse bites. The metal corrosion does not influence the device yield, but reduces reliability of the devices. Moreover, the defect count of the wafer on KLA map is very large, which shields other defects related to the device yield. As a result, the other defects can be not found out at on-line monitoring.

In accordance with the above clean steps, the mechanism of removing polymer residues on the sidewalls of the metal lines with the stripping solution is the stripping solution attacks aluminum or its oxide to remove polymer residues from the sidewalls of the aluminum metal lines, and then dissolving the removed polymer residues in the stripping solution. The mechanism is shown in the following:

R—NH₂+H₂O→R—NH₃_{⁺}+OH—

2Al+2OH—+2H₂O→2AlO₂_{⁻}+3H₂

When there is excess water in the stripping solution, the mechanism is as follows:

R—NH₂+H₂O→R—NH₃_{⁺}+OH—

2Al+2OH—+6H₂O→2Al(OH)₄_{⁻}+3H₂

Metal corrosion would occur on the sidewalls of the metal lines 102, as shown in FIG. 2.

Referring to FIG. 4, which is a diagram of aluminum etching rate v.s. water content of the stripping solution when using the stripping solution containing alcohol amine, dihydroxylbenzene, water, hydroxylamine and anticorrosion agent to clean aluminum alloy. As shown in FIG. 4, when water content is below 60 wt. %, aluminum etching rate is smaller than 0.1 Å/min, while water content is up to 98 wt. %, aluminum etching rate is up to 58 Å/min. It is apparent that a little of the stripping solution in a large quantity of water would result in serious metal corrosion on aluminum alloy.

Therefore, the stripping solution left on the wafer needs to be completely removed before immersing the wafer in the overflow bath 322 so as to avoid metal corrosion occurring on the sidewalls of the metal lines 102 formed on the wafer.

Accordingly, it is an intention to provide an improved clean equipment and method thereof to overcome the drawbacks of the prior art.

### SUMMARY OF THE INVENTION

It is an objective of the present invention to provide a clean equipment for removing polymer residues on sidewalls of metal lines, in which a gas bubbler is positioned under a lattice-like cassette stage in an organic solvent bath, and the gas bubbler is designed in a way that the bubbling apertures of the gas bubbler is prevented from being blocked by the lattice-like cassette stage. Thereby, a stripping solution left on a wafer can be effectively removed with the organic solvent. The quantity of the stripping solution drawn into an overflow bath by the wafer is eliminated, and metal corrosion of the sidewalls of the metal lines is significantly reduced.

It is another objective of the present invention to provide a method for removing polymer residues on sidewalls of metal lines, in which the drip dry time of a wafer over each bath of the present clean equipment is lengthened so as to eliminate the quantity of a stripping solution left on the wafer drawn into the overflow bath. Thus, metal corrosion occurred on the sidewalls of the metal lines formed on the wafer is significantly reduced.

It is a further objective of the present invention to provide a method for removing polymer residues on sidewalls of metal lines, which implements the measure of the combination of increasing the number of bubbling apertures of the gas bubbler, designing the gas bubbler structure in a way that preventing the bubbling apertures from being blocked by the lattice-like cassette stage and lengthening the drip dry time of the wafer over each bath, so as to eliminate the quantity of the stripping solution left on the wafer drawn into the overflow bath. Metal corrosion occurred on the sidewalls of the metal lines formed on the wafer is thus reduced.

In order to achieve the above objectives, the present invention provides a clean equipment for removing polymer residues on sidewalls of metal lines and method thereof. The present clean equipment comprises a first bath, a second bath, an overflow bath and a dryer. The first bath contains an organic solvent for removing polymer residues on sidewalls of metal lines formed on a wafer. The second bath contains an organic solvent for removing the stripping solution left on the wafer. The second bath is provided with a gas bubbler for providing gas flow and a lattice-like cassette stage for supporting cassette for carrying wafers. The gas bubbler is positioned on the bottom of the second bath within the second bath and the lattice-like cassette stage is positioned over the gas bubbler. The gas bubbler comprises a main flow tube and at least two branching tubes. Each branching tube is provided with a plurality of pairs of side flow tubes, and vertically communicated with the main flow tube. Each pair of the side flow tubes is correspondingly and vertically communicated with two opposite sides of the branching tube and parallel with the main flow tube. A bubbling aperture of each side flow tube is positioned under a lattice of the lattice-like cassette stage. The overflow bath is used for providing water flow to remove away the organic solvent and the stripping solution left on the wafer. The dryer is used for drying water left on the wafer. In the present invention, by way of increasing the number of bubbling apertures of the gas bubbler and designing the gas bubbler structure in a way that preventing the bubbling apertures from being blocked by the lattice-like cassette stage, the convection effectiveness of the organic solvent is increased. As a result, the stripping solution is effectively removed with the organic solvent. Besides, lengthening the drip dry time of the wafer over each bath so as to eliminate the quantity of the stripping solution left on the wafer drawn in the overflow bath. By the above measures, metal corrosion occurred on the sidewalls of the metal lines formed on the wafer is significantly reduced.

### BRIEF DESCRIPTION OF THE DRAWINGS

The present invention can be best understood through the following description and accompanying drawings, wherein:

FIG. 1 shows a schematic cross-sectional view of a metal line structure;

FIG. 2 shows a schematic cross-sectional view of a metal line having metal corrosion occurred on a sidewall thereof;

FIG. 3 is a schematic view of a conventional clean equipment for removing polymer residues on sidewalls of metal lines;

FIG. 4 is a diagram of aluminum etching rate v.s. water content in a stripping solution when cleaning the aluminum metal with the stripping solution;

FIG. 5A is a top view of a gas bubbler and a lattice-like wafer carrier of the present invention;

FIG. 5B is a front view of the gas bubbler and the lattice-like wafer carrier of FIG. 5A; and

FIG. 6 shows progression steps for cleaning polymer residues on sidewalls of metal lines with the present clean equipment.

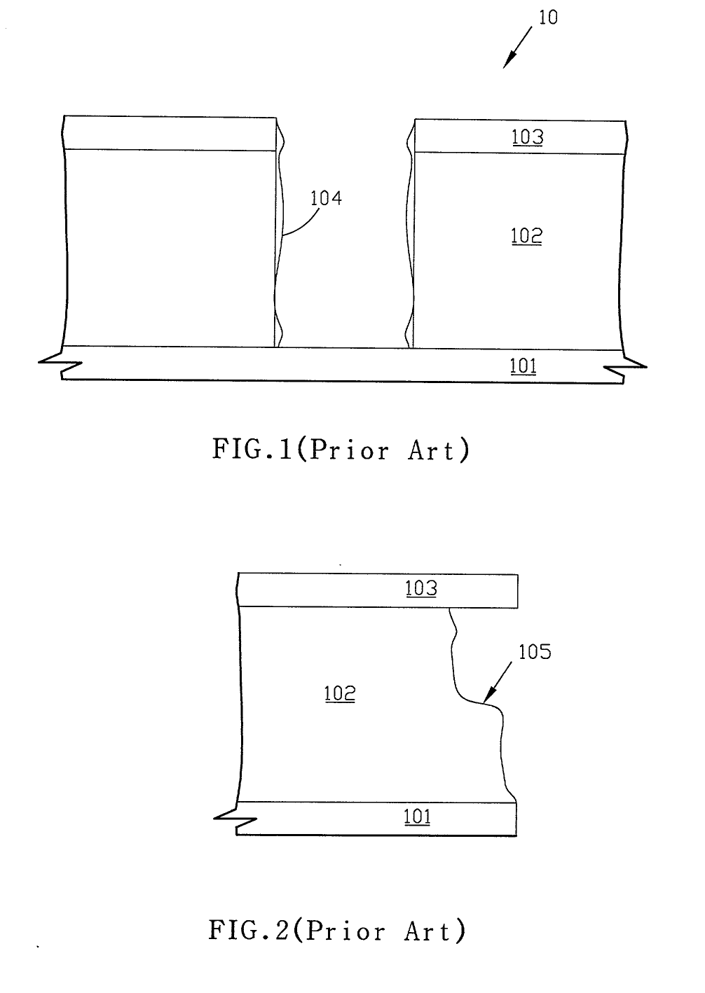

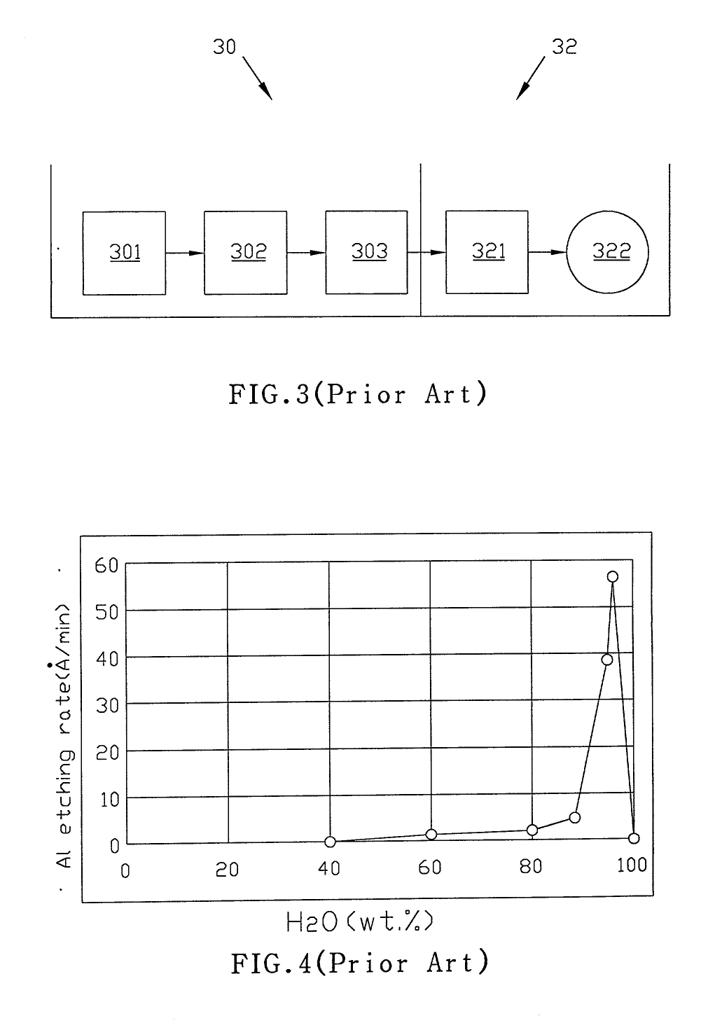

### DESCRIPTION OF THE PREFERRED EMBODIMENTS

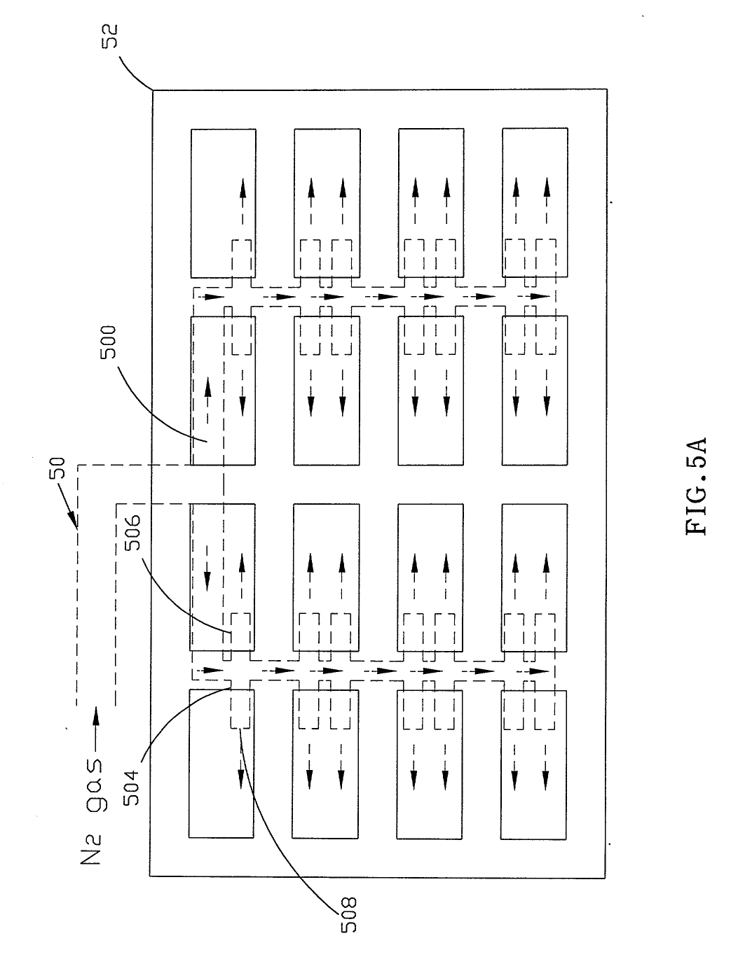

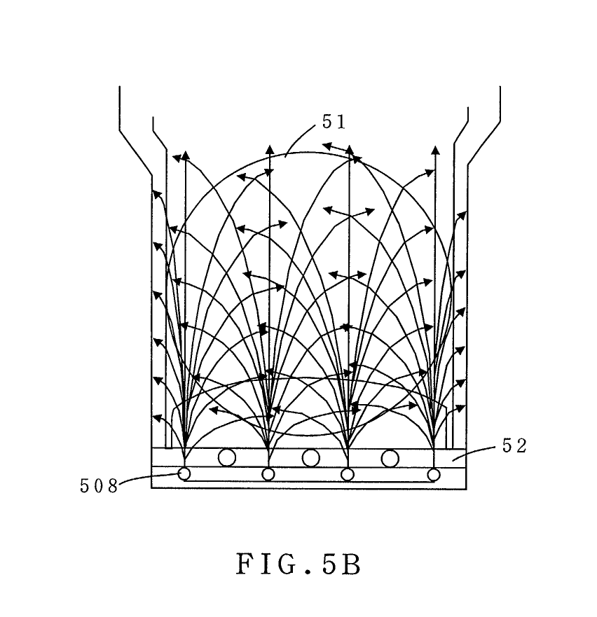

The present invention provides a clean equipment for removing polymer residues on sidewalls of metal lines. The present clean equipment comprises a first bath, a second bath, an overflow bath and a dryer. The first bath contains a stripping solution for removing polymer residues on sidewalls of metal lines formed on a wafer. The second bath contains an organic solvent for removing the stripping solution left on the wafer. Referring to FIG. 5A, the second bath is provided with a gas bubbler 50 and a lattice-like cassette stage 52. The gas bubbler 50 is positioned on the bottom of the second bath within the second bath and the lattice-like cassette stage 52 is positioned over the gas bubbler 50. The gas bubbler 50 comprises a main flow tube 500 and at least two branching tubes 502. Each branching tube 502 is provided with a plurality of pairs of side flow tubes 504 and 506, and vertically communicated with the main flow tube 500. Each pair of the side flow tubes 504 and 506 is correspondingly and vertically communicated with two opposite sides of the branching tube 502 and parallel with the main flow tube 500. A bubbling aperture 508 of each side flow tube 504 or 506 is positioned under a lattice of the lattice-like cassette stage 52 so as to prevent the bubbling aperture 508 from being blocked by the lattice-like cassette stage 52, as shown in FIG. 5B. Referring to FIG. 5B, the gas bubbler 50 provides gas flow in the organic solvent contained in the second bath through the bubbling apertures 508 to provide convection of the organic solvent except for the diffusion function. As a result, the stripping solution left on the wafer is effectively removed with the organic solvent. The overflow bath is used for providing water flow to remove away the organic solvent and the stripping solution left on the wafer. The dryer is used for spin drying water left on the wafer. Preferably, the dryer can be a spin dryer for spin drying water left on the wafer.

It is preferable to provide a third bath between the second bath and the overflow bath. The third bath contains an organic solvent the same with that contained in the second bath to further removing the stripping solution left on the wafer. Referring to FIG. 5A, it is more preferable to install a gas bubbler 50 and a lattice-like cassette stage 52 in the third bath to provide convection of the organic solvent contained in the third bath. Thereby, the stripping solution left on the wafer 51 can be effectively removed with the organic solvent contained in the third bath.

In another respect, the present invention provides a clean station for removing polymer residues on sidewalls of metal lines. The present clean station comprises at least four stops. The first stop is provided with a stripping solution bath for removing the polymer residues on the sidewalls of metal lines. The second stop is provided with a first organic solvent bath for removing the stripping solution left on the wafer. The first organic solvent bath is provided with a gas bubbler 50 and a lattice-like cassette stage 52. The gas bubbler 50 is positioned on the bottom of the first organic solvent bath within the first organic solvent bath and the lattice-like cassette stage 52 is positioned over the gas bubbler 50. The gas bubbler 50 comprises a main flow tube 500 and at least two branching tubes 502. Each branching tube 502 is provided with a plurality of pairs of side flow tubes 504 and 506, and vertically communicated with the main flow tube 500. Each pair of the side flow tubes 504 and 506 is correspondingly and vertically communicated with two opposite sides of the branching tube 502 and parallel with the main flow tube 500. A bubbling aperture 508 of each side flow tube 504 or 506 is positioned under a lattice of the lattice-like cassette stage 52 so as to prevent the bubbling aperture 508 from being blocked by the lattice-like cassette stage 52. The third stop is provided with an overflow bath for providing water flow to remove away the first organic solvent and the stripping solution left on the wafer. The fourth stop is provided with a dryer for drying water left on the wafer. Preferably, the dryer can be a spin dryer for spin drying water left on the wafer.

It is preferable to provide a fifth stop between the second stop and the third stop. The fifth stop is provided with a second organic solvent bath containing a second organic solvent the same with that contained in the first organic solvent bath to further removing the stripping solution left on the wafer. It is more preferable to install a gas bubbler 50 and a lattice-like cassette stage 52 in the second organic solvent bath to provide convection of the second organic solvent contained in the second organic solvent bath. Thereby, the stripping solution left on the wafer 51 can be effectively removed with the second organic solvent contained in the second organic solvent bath.

The present invention also provides a method for removing polymer residues on sidewalls of metal lines. In accordance with the present method, a wafer with at least a metal line layer formed thereon is provided. The sidewalls of the metal lines of the metal line layer have polymer residues formed thereon due to a prior dry etching process for forming the metal line layer. The wafer is immersed in a stripping solution for removing the polymer residues in accordance with a first immersion time. Then, the wafer is removed from the stripping solution and maintaining for a first time such that the stripping solution left on the wafer drips down. Thereafter, the wafer is immersed in a first organic solvent for removing the stripping solution left on the wafer in accordance with a second immersion time. Then, the wafer is removed from the first organic solvent and maintaining for a second time so that the stripping solution and the first organic solvent left on the wafer drip down. Afterward, the wafer is immersed in a water flow for removing the stripping solution and the first organic solvent left on the wafer in accordance with a third immersion time. However, prior to immersing the wafer in the water flow, it is preferable to immerse the wafer in a second organic solvent for more completely removing the stripping solution left on the wafer in accordance with a fourth immersion time. Then, the wafer is removed from the second organic solvent and maintaining for a third time so that the stripping solution, the first organic solvent and the second solvent drip down. Finally, removing water left on the wafer in accordance with a predetermined time.

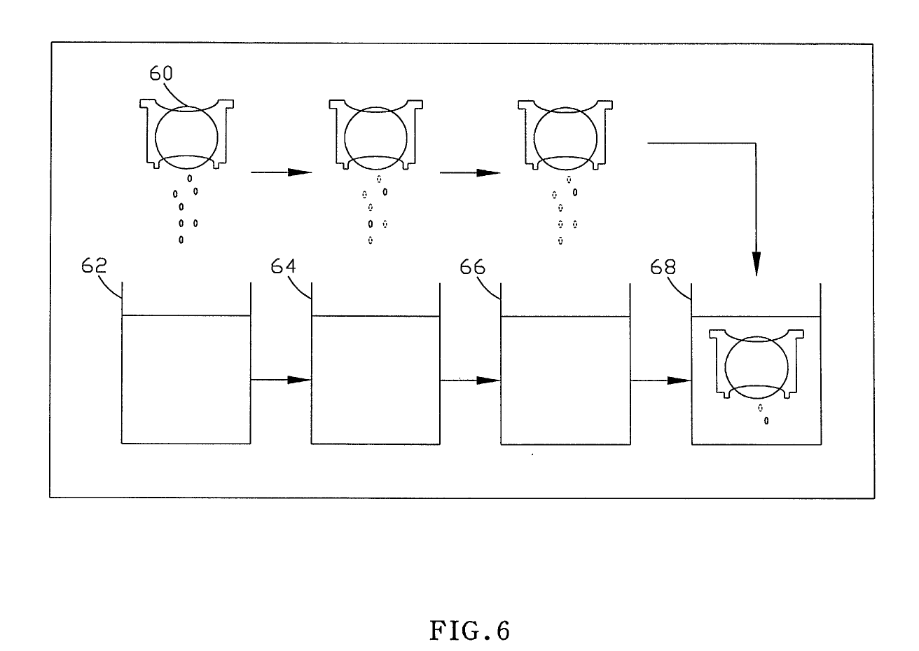

A first preferred embodiment of the present method is described in detail with reference to FIG. 6. At first, a lot of wafers 60 are immersed in a stripping solution bath 62 for about 10 minutes to remove polymer residues on sidewalls of metal lines. The stripping solution comprises alcohol amine, dihydroxylbenzene, water, hydroxyl amine and anticorrosion agent. Then, the wafer 60 is removed from the stripping solution bath 62 and placed over the stripping solution bath 62. The stripping solution left on the wafer 60 drips down in accordance with a first drip dry time, i.e. a first stay time over the stripping solution bath 62, for about 100 seconds, as shown by solid circles in FIG. 6. Following, the wafer 60 is immersed in a first methanol bath 64 for about 5 minutes for removing the stripping solution left on the wafer 60. Then, the wafer 60 is removed from the first methanol bath 64 and placed over the first methanol bath 64. The stripping solution and methanol left on the wafer 60 drip down in accordance with a second drip dry time, i.e. a second stay time over the first methanol bath 64. As shown in FIG. 6, the solid circle represents a drop of the stripping solution and the dashed circle represents a drop of methanol. Thereafter, the wafer 60 is immersed in an overflow bath 68 to remove away the stripping solution and methanol left on the wafer 60. Finally, spin drying water left on the wafer 60 with a spin dryer (not shown).

Referring to FIG. 6, according to a second preferred embodiment of the present method, prior to immersing the wafer 60 in the overflow bath 68, the wafer 60 is immersed in a second methanol bath 66 for about 5 minutes such that the stripping solution left on the wafer 60 with methanol can be removed more effectively. Then, the wafer 60 is removed from the second methanol bath 66 and placed over the second methanol bath 66. The stripping solution and methanol left on the wafer 60 drip down in accordance with a third drip dry time, i.e. a third stay time over the second methanol bath 66, for about 50 seconds. The other steps of the second preferred embodiment are the same with those of the first preferred embodiment.

Alternately, the first methanol bath 64 and the second methanol bath 66 can be replaced by isopropyl alcohol bathes or bathes containing other alcohol (ROH).

Both of the first preferred embodiment and second preferred embodiment utilize the measure of lengthening the drip dry time of the wafer 60 staying over each bath to eliminate the quantity of the stripping solution left on the wafer 60 drawn into the overflow bath 68. As a result, metal corrosion occurred on sidewalls of metal lines formed on the wafer 60 is reduced.

According to a third preferred embodiment of the present invention, an inert gas flow is provided into the first methanol bath 64 through the gas bubbler 50 to increase convection of methanol, and thereby the stripping solution left on the wafer 60 can be effectively removed with methanol. The third preferred embodiment is described in detail below. At first, a lot of wafers 60 are immersed in the stripping solution bath 62 for about 10 minutes to remove polymer residues on sidewalls of metal lines formed on the wafer 60. The composition of the stripping solution is the same with that used in the first preferred embodiment. Following, the wafer 60 is immersed in the first methanol bath 64 for about 5 minutes for removing the stripping solution left on the wafer 60. The first methanol bath 64 is provided with a gas bubbler 50 and a lattice-like cassette stage 52. The geometrically relationship between the gas bubbler 50 and the lattice-like cassette stage 52 in the first methanol bath 64 is as shown in FIG. 5A. A gas flow with a flow rate of about 15 liters/per minute is provided into the first methanol bath 64 through the gas bubbler 50 to increase convection of methanol. The inert gas flow can be nitrogen gas flow. Thereby, the stripping solution left on the wafer 60 cab be effectively removed with methanol. Thereafter, the wafer 60 is immersed in the second methanol bath 66 for about 5 minutes for further removing the stripping solution left on the wafer 60. Then, the wafer 60 is immersed in the overflow bath 68 to remove away the stripping solution and methanol left on the wafer 60. Finally, spin drying water left on the wafer 60 with a spin dryer (not shown).

Alternately, the first methanol bath 64 and the second methanol bath 66 can be replaced with isopropyl alcohol bathes or bathes containing other alcohol (ROH) in the third preferred embodiment.

According to a fourth preferred embodiment of the present invention, both of the first methanol bath 64 and the second methanol bath 66 are provided with the gas bubbler 50 and the lattice-like cassette stage 52, as shown in FIG. 5A. The inert gas with a flow rate of about 15 liters/per minute is provided in the first methanol bath 64 and the second methanol bath 66 through the gas bubbler 50. The inert gas flow can be nitrogen gas flow. Besides, the other steps of the fourth preferred embodiment are the same with those of the third preferred embodiment.

Alternately, the first methanol bath 64 and the second methanol bath 66 can be replaced with isopropyl alcohol bathes or bathes containing other alcohol (ROH) in the fourth preferred embodiment.

According to a fifth preferred embodiment of the present invention, a measure for combination of lengthening drip dry time of the wafer 60 over each bath and providing inert gas flow in the bathes to eliminate the quantity of the stripping solution left on the wafer 60 before the wafer 60 is immersed in the overflow bath 68 is implemented. In the fifth preferred embodiment, the first methanol bath 64 and the second methanol bath 66 are provided with the gas bubbler 50 and the lattice-like cassette stage 52, as shown in FIG. 5A. The inert gas flow is provided in the first methanol bath 64 and the second methanol bath 66 through the gas bubbler 50. The inert gas flow can be nitrogen gas. The fifth preferred embodiment is described in detail below. At first, the wafer 60 is immersed in the stripping solution bath 62 for about 10 minutes to remove polymer residues on sidewalls of metal lines formed on the wafer 60. The composition of the stripping solution is the same with that used in the first preferred embodiment. Then, the wafer 60 is removed from the stripping solution bath 62 and placed over the stripping solution bath 62. The stripping solution left on the wafer 60 drips down in accordance with a first drip dry time, i.e. a first stay time over the stripping solution bath 62, for about 100 seconds. Following, the wafer 60 is immersed in the first methanol bath 64, being provided with the inert gas flow, for about 5 minutes. The inert gas flow increases convection of methanol contained in the first methanol bath 64, and thereby the stripping solution can be removed with methanol more effectively. Then, the wafer 60 is removed from the first methanol bath 64 and placed over the first methanol bath 64. The stripping solution and methanol left on the wafer 60 drip down in accordance with a second drip dry time, i.e. a second stay time over the first methanol bath 64, for 50 seconds. Thereafter, the wafer 60 is immersed in the second methanol bath 66, provided with the inert gas flow, for about 5 minutes for further removing the stripping solution left on the wafer 60. The inert gas flow increase convection of methanol contained in the second methanol bath 64, and thereby the stripping solution left on the wafer 60 can be removed with methanol more effectively. Then, the wafer 60 is removed from the second methanol bath 64 and placed over the second methanol bath 64. The stripping solution and methanol left on the wafer 60 drip down in accordance with a third drip dry time, i.e. a third stay time over the second methanol bath 64, for 50 seconds. Afterward, the wafer 60 is immersed in the overflow bath 68 to remove away the stripping solution and methanol left on the wafer 60. Finally, spin drying water left on the wafer 60 with a spin dryer.

Alternately, the first methanol bath 64 and the second methanol bath 66 can be replaced with isopropyl alcohol bathes or bathes containing other alcohol (ROH) in the fifth preferred embodiment.

In the fifth preferred embodiment, when the first methanol bath 64 and the second methanol bath 66 are provided with nitrogen gas flow with a flow rate of about 5 liters/per minute, metal corrosion occurred on the wafer 60 is reduced about 82%. When the first methanol bath 64 and the second methanol bath 66 are provided with nitrogen gas flow with a flow rate of about 15 liters/per minute, metal corrosion occurred on the wafer 60 is reduced about 89%. Besides, in accordance with the fifth preferred embodiment, in case that one lot of wafers 60 are immersed in the bathes per run time, methanol contained in the first methanol bath 64 and the second methanol bath 66 are exchanged with fresh methanol after 15 run times. However, for the conventional method without providing with the inert gas flow and implementing the drip dry method, methanol contained in the methanol bath needs to be exchanged with fresh methanol after 5 run times. Thus, the present method not only significantly reduces metal corrosion occurred on the wafer 60, but also saves a large quantity of methanol. The cost down is obtained.

The defect count of the wafer 60 on KLA map is larger than 20000 when using the conventional method to remove polymer residues on sidewalls of metal lines formed on the wafer 60. The defect count of the wafer 60 on KLA map is larger than 10000 when using the present method for removing polymer residues on sidewalls of metal lines formed on the wafer 60 that the first methanol bath 64 and the second methanol bath 66 are provided with nitrogen gas flow. However, the defect count of the wafer 60 on KLA map is smaller than 1000 when using the present method for removing polymer residues on sidewalls of metal lines formed on the wafer 60 that the first methanol bath 64 and the second methanol bath 66 are provided with nitrogen gas flow and the drip dry time over each bath is lengthened. Thus, metal corrosion occurred on the wafer 60 is significantly reduced in accordance with the present invention to remove polymer residues on sidewalls of metal lines formed on the wafer 60.

The preferred embodiments are only used to illustrate the present invention, not intended to limit the scope thereof. Many modifications of the preferred embodiments can be made without departing from the spirit of the present invention.

What is claimed is:

1. A clean equipment for removing polymer residues on sidewalls of metal lines, comprising:
a first bath containing a stripping solution for removing polymer residues on sidewalls of metal lines formed on a wafer;
a second bath containing an organic solvent for removing the stripping solution left on the wafer, said second bath being provided with a gas bubbler for providing gas flow and a lattice-like cassette stage for supporting cassettes for carrying the wafers, said gas bubbler positioned on the bottom of said second bath within said second bath and said lattice-like cassette stage positioned over said gas bubbler, wherein said gas bubbler comprises a main flow tube and at least two branching tubes, each said branching tube provided with a plurality of pairs of side flow tubes, and each said branching tube vertically communicated with said main flow tube, each pair of said side flow tubes correspondingly and vertically communicated with two opposite sides of said branching tube and parallel with said main flow tube, and a bubbling aperture of each said side flow tube positioned under a lattice of said lattice-like wafer carrier;
an overflow bath for providing water flow to remove away the organic solvent and the stripping solution left on the wafer; and
a dryer for drying water left on the wafer.

2. The clean equipment of claim 1, wherein a third bath is positioned between said second bath and said overflow bath, said third bath containing an organic solvent the same with that contained in said second bath for further removing the stripping solution left on the wafer.

3. The clean equipment of claim 1, wherein said third bath is provided with a gas bubbler for providing gas flow and a lattice-like cassette stage for supporting cassettes for carrying the wafers, said gas bubbler positioned on the bottom of said third bath within said third bath and said lattice-like cassette stage positioned over said gas bubbler, wherein said gas bubbler comprises a main flow tube and at least two branching tubes, each said branching tube provided with a plurality of pairs of side flow tubes, and each said branching tube vertically communicated with said main flow tube, each pair of said side flow tubes correspondingly and vertically communicated with two opposite sides of said branching tube and parallel with said main flow tube, and a bubbling aperture of each said side flow tube positioned under a lattice of said lattice-like cassette stage.

4. The clean equipment of claim 1, wherein the stripping solution comprises alcohol amine, water, dihydoxylbenzene, hydroxyl amine and anticorrosion agent.

5. The clean equipment of claim 1, wherein the organic solvent comprises alcohol (ROH).

6. The clean equipment of claim 5, wherein the organic solvent comprises methanol.

7. The clean equipment of claim 5, wherein the organic solvent comprises isopropyl alcohol.

8. The clean equipment of claim 1, wherein said gas bubbler positioned in said second bath is used for providing inert gas flow.

9. The clean equipment of claim 8, wherein said gas bubbler positioned in said second bath is used for providing nitrogen gas flow.

10. The clean equipment of claim 3, wherein said gas bubbler positioned in said third bath is used for providing inert gas flow.

11. The clean equipment of claim 10, wherein said gas bubbler positioned in said third bath is used for providing nitrogen gas flow.

12. A clean station for removing polymer residues on sidewalls of metal lines, comprising:
a first stop provided with a stripping solution bath for removing polymer residues on sidewalls of metal lines formed on a wafer;
a second stop provided with a first organic solvent bath for removing the stripping solution left on the wafer, said first organic solvent bath being provided with a gas bubbler for providing gas flow and a lattice-like cassette stage for supporting cassettes for carrying the wafers, said gas bubbler positioned on the bottom of said first organic solvent bath within said first organic solvent bath and said lattice-like cassette stage positioned over said gas bubbler, wherein said gas bubbler comprises a main flow tube and at least two branching tubes, each said branching tube provided with a plurality of pairs of side flow tubes, and each said branching tube vertically communicated with said main flow tube, each pair of said side flow tubes correspondingly and vertically communicated with two opposite sides of said branching tube and parallel with said main flow tube, and a bubbling aperture of each said side flow tube positioned under a lattice of said lattice-like wafer carrier;
a third stop provided with an overflow bath for providing water flow to remove away the first organic solvent and the stripping solution left on the wafer; and
a fourth stop provided with a dryer for drying water left on the wafer.

13. The clean station of claim 12, wherein a fifth stop is positioned between said second stop and said third stop, said fifth stop provided with a second organic solvent bath containing a second organic solvent the same with that contained in said first organic solvent bath for further removing the stripping solution left on the wafer.

14. The clean station of claim 13, wherein said second organic solvent bath is provided with a gas bubbler for providing gas flow and a lattice-like cassette stage for supporting cassettes for carrying the wafers, said gas bubbler positioned on the bottom of said second organic solvent bath within said second organic solvent bath and said lattice-like cassette stage positioned over said gas bubbler, wherein said gas bubbler comprises a main flow tube and at least two branching tubes, each said branching tube provided with a plurality of pairs of side flow tubes, and each said branching tube vertically communicated with said main flow tube, each pair of said side flow tubes correspondingly and vertically communicated with two opposite sides of said branching tube and parallel with said main flow tube, and a bubbling aperture of each said side flow tube positioned under a lattice of said lattice-like cassette stage.

15. The clean station of claim 12, wherein the stripping solution comprises alcohol amine, water, dihydoxylbenzene, hydroxyl amine and anticorrosion agent.

16. The clean station of claim 12, wherein the first organic solvent comprises alcohol (ROH).

17. The clean station of claim 16, wherein the first organic solvent comprises methanol.

18. The clean station of claim 16, wherein the first organic solvent comprises isopropyl alcohol.

19. The clean station of claim 13, wherein the second organic solvent comprises alcohol (ROH).

20. The clean station of claim 19, wherein the second organic solvent comprises methanol.

21. The clean station of claim 19, wherein the second organic solvent comprises isopropyl alcohol.

22. The clean station of claim 12, wherein said gas bubbler positioned in said first organic solvent bath is used for providing inert gas flow.

23. The clean station of claim 22, wherein said gas bubbler positioned in said first organic solvent bath is used for providing nitrogen gas flow.

24. The clean station of claim 13, wherein said gas bubbler positioned in said second organic solvent bath is used for providing inert gas flow.

25. The clean station of claim 24, wherein said gas bubbler positioned in said second organic bath is used for providing nitrogen gas flow.

26. A method for removing polymer residues on sidewalls of metal lines, comprising:
providing a wafer with at least a metal line layer formed thereon, the sidewalls of the metal lines of the metal line layer having polymer residues formed thereon;
immersing said wafer in a stripping solution for removing the polymer residues in accordance with a first immersion time;
removing said wafer from said stripping solution and maintaining for a first time so that said stripping solution left on said wafer drips down;
immersing said wafer in a first organic solvent for removing said stripping solution left on said wafer in accordance with a second immersion time;
removing said wafer from said first organic solvent and maintaining for a second time so that said striping solution and said first organic solvent left on said wafer drip down;
immersing said wafer in a water flow for removing the stripping solution and said first organic solvent left on said wafer in accordance with a third immersion time; and
removing water left on said wafer in accordance with a predetermined time.

27. The method of claim 26, wherein said first immersion time is about 10 minutes.

28. The method of claim 26, wherein said first time is about 100 seconds.

29. The method of claim 26, wherein said second immersion time is about 5 minutes.

30. The method of claim 26, wherein said second time is about 50 seconds.

31. The method of claim 26, wherein said third immersion time is about 10 minutes.

32. The method of claim 26, wherein said predetermined time is about 10 minutes.

33. The method of claim 26, wherein said stripping solution comprises alcohol amine, water, dihydoxylbenzene, hydroxyl amine and anticorrosion agent.

34. The method of claim 26, wherein said first organic solvent comprises alcohol (ROH).

35. The method of claim 34, wherein said first solvent comprises methanol.

36. The method of claim 34, wherein said first solvent comprises isopropyl alcohol.

37. The method of claim 26, wherein prior to immersing said wafer in said water flow, further comprising immersing said wafer in a second organic solvent for further removing said stripping solution left on said wafer in accordance with a fourth immersion time, and removing said wafer from said second organic solvent and maintaining for a third time so that said stripping solution, said first organic solvent and said second organic solvent drip down.

38. The method of claim 37, wherein said fourth immersion time is about 5 minutes.

39. The method of claim 37, wherein said third time is about 50 seconds.

40. The method of claim 37, wherein said second organic solvent comprises alcohol (ROH).

41. The method of claim 40, wherein said second organic solvent comprises methanol.

42. The method of claim 40, wherein said second organic solvent comprises isopropyl alcohol.

43. The method of claim 26, wherein further comprising providing an inert gas flow in said first organic solvent.

44. The method of claim 43, wherein said inert gas flow comprises nitrogen gas flow.

45. The method of claim 43, wherein the flow rate of said inert gas flow is about 15 liters/per minute.

46. The method of claim 44, wherein the flow rate of said nitrogen gas flow comprises 15 liters/per minute.

47. The method of claim 37, wherein further comprising providing an inert gas flow in said second organic solvent.

48. The method of claim 47, wherein said inert gas flow comprises nitrogen gas flow.

49. The method of claim 47, wherein the flow rate of said inert gas flow is about 15 liters/per minute.

50. The method of claim 48, wherein the flow rate of said nitrogen gas flow is about 15 liters/per minute.
